(19) United States
(12) Patent Application Publication
(10) Pub. No.: US 2023/0213431 A1
(43) Pub. Date: Jul. 6, 2023

(54) Particle Separation Device, Method, and Program, Structure of Particle Separation Data, and Leaned Model Generation Method

(71) Applicant: Nippon Telegraph and Telephone Corporation, Tokyo (JP)

(72) Inventors: Kenta Fukada, Tokyo (JP); Michiko Seyama, Tokyo (JP)

(21) Appl. No.: 17/927,065

(22) PCT Filed: Jun. 2, 2020
(86) PCT No.: PCT/JP2020/021735

§ 371 Date: Nov. 22, 2022

(51) Int. Cl. G01N 15/14

(52) U.S. Cl. CPC G01N 15/1404; G01N 2015/1493; G01N 2015/1402; G01N 2015/149

(57) ABSTRACT

A particle sorting apparatus for separating particles according to the sizes of the particles, and includes a microchannel device, a computation unit that determines a condition for controlling the microchannel device using a trained model obtained through machine learning of control condition data and separation result data that have been obtained by separating particles while controlling the microchannel device, and a control unit that controls the microchannel device based on the condition.

### CROSS-REFERENCE TO RELATED APPLICATIONS

This application is a national phase entry of PCT Application No. PCT/JP2020/021735, filed on Jun. 2, 2020, which application is hereby incorporated herein by reference.

### TECHNICAL FIELD

The present invention relates to an apparatus, method, and program for easily sorting particles, a data structure of particle sorting data, and a method for generating a trained model.

### BACKGROUND

In the industrial field, environmental field, and medicinal chemistry field, particles are used as metal beads or resin beads, and are included in ceramics, cells, or pharmaceuticals, for example, and thus are applied in a variety of forms. Therefore, a technique for sorting particles is important.

As a technique for sorting particles, Non-Patent Literature 1 discloses a particle sorting apparatus using a microchannel. The apparatus is adapted to separate particles flowing through the microchannel according to size and collect the separated particles, and is used to sort microbeads or cells in the blood, for example. The separation is achieved by utilizing a laminar flow that occurs at a point where two (bifurcated) channels merge, and based on the difference in forces applied to the flowing particles depending on the sizes of the particles. Accordingly, micron-order particles can be sorted and collected.

### CITATION LIST

### Non-Patent Literature

Non-Patent Literature 1: Yamada, M. et al, “Pinched Flow Fractionation: Continuous Size Separation of Particles Utilizing a Laminar Flow Profile in a Pinched Microchannel”, Anal. Chem., 2004, 76, 5465.

### SUMMARY

### Technical Problem

However, the technique disclosed in Non-Patent Literature 1 is applicable only to a fluid with constant viscosity, and when the technique is applied to a liquid (a liquid substance), such as the blood, that has various levels of viscosity and that undergoes changes in viscosity with time, variation in sorting conditions or accuracy may occur.

Meanwhile, although a plurality of types of anticoagulants may be used for a fluid with various levels of viscosity to obtain constant viscosity, the viscosity may possibly become too high in some cases, causing a problem such as clogging of a suction tube in the apparatus, for example.

As described above, with the conventional technique, it is impossible to sufficiently accommodate the viscosities of samples (liquids), as well as distributions of the sizes of particles contained in the samples or the concentrations of particles in the sample. To accommodate the viscosity of a sample, it would be necessary to optimize the flow rate based on the device structure in conformity with the viscosity of the sample. Consequently, considering the time and cost required to produce a device with an optimum structure, there is a problem with convenience. Thus, it would be difficult to apply the conventional technique to biological samples with great individual variation, for example.

Embodiments of the present invention provide an apparatus, method, and program for easily sorting particles using a microchannel device, a data structure of particle sorting data, and a method for generating a trained model.

### Means for Solving the Problem

To solve the aforementioned problems, a particle sorting apparatus according to embodiments of the present invention is a particle sorting apparatus for separating particles according to the sizes of the particles, including a microchannel device, a computation unit that determines a condition for controlling the microchannel device using a trained model obtained through machine learning of control condition data and separation result data that have been obtained by separating particles while controlling the microchannel device, and a control unit that controls the microchannel device based on the condition.

A particle sorting method according to embodiments of the present invention is a particle sorting method for separating particles according to the sizes of the particles using a microchannel device, including a step of determining a condition for controlling the microchannel device using a trained model obtained through machine learning of control condition data and separation result data that have been obtained by separating particles while controlling the microchannel device, and a step of controlling the microchannel device based on the condition.

A particle sorting program according to embodiments of the present invention causes a particle sorting apparatus for separating particles according to the sizes of the particles using a microchannel device to execute a process including a step of determining a condition for controlling the microchannel device using a trained model obtained through machine learning of control condition data and separation result data that have been obtained by separating particles while controlling the microchannel device, and a step of controlling the microchannel device based on the condition.

A data structure of particle sorting data according to embodiments of the present invention is a data structure of particle sorting data used for a particle sorting apparatus including a microchannel device, a storage unit, and a computation unit, the data structure of the particle sorting data being stored in the storage unit and including control condition data for the microchannel device, and separation result data paired with the control condition data, in which the data structure of the particle sorting data is used for a process of the computation unit to determine a condition for controlling the microchannel device using a trained model obtained through machine learning of the control condition data and the separation result data obtained from the storage unit.

A method for generating a trained model according to embodiments of the present invention includes a step of obtaining, from training data including control condition data and separation result data that have been obtained by separating particles while controlling a microchannel device at a first time point, first separation result data at the first time point, a step of obtaining, from training data including control condition data and separation result data that have been obtained by separating particles while controlling the microchannel device at a second time point, second separation result data at the second time point, a step of calculating a first score by multiplying separation result data obtained through machine learning of the first separation result data by a reward value, a step of calculating a second score by multiplying the second separation result data by the reward value, and a step of comparing the first score with the second score.

### Effects of Embodiments of the Invention

According to the present invention, an apparatus and method for easily sorting particles using a microchannel device can be provided.

### BRIEF DESCRIPTION OF THE DRAWINGS

FIG. 1 is a block diagram illustrating the basic configuration of a particle sorting apparatus according to a first embodiment of the present invention.

FIG. 2 is a general view (top view) illustrating a configuration example of a microchannel device according to the first embodiment of the present invention.

FIG. 3 is a schematic view illustrating a configuration example of the particle sorting apparatus according to the first embodiment of the present invention.

FIG. 4 is a chart illustrating an example of separation result data according to the first embodiment of the present invention.

FIG. 5 is a schematic view illustrating an example of the setting of reward values according to the first embodiment of the present invention.

FIG. 6 is a schematic view illustrating a comparative example of the setting of reward values according to the first embodiment of the present invention.

FIG. 7 is a schematic view illustrating a comparative example of the setting of reward values according to the first embodiment of the present invention.

FIG. 8 is a chart illustrating an example of training data according to the first embodiment of the present invention.

FIG. 9 is a chart illustrating a comparative example of training data according to the first embodiment of the present invention.

FIG. 10 is a chart illustrating a comparative example of training data according to the first embodiment of the present invention.

FIG. 11 is a view for illustrating a method for generating a trained model (an inference model) through machine learning according to the first embodiment of the present invention.

FIG. 12 is a flowchart of the method for generating a trained model (an inference model) through machine learning according to the first embodiment of the present invention.

FIG. 13 illustrates changes in loss during a process of generating a trained model (an inference model) according to the first embodiment of the present invention.

FIG. 14 is a view for illustrating inference according to the first embodiment of the present invention.

FIG. 15 is a flowchart of inference according to the first embodiment of the present invention.

FIG. 16 is a schematic view illustrating a process of sorting particles with the particle sorting apparatus according to the first embodiment of the present invention.

FIG. 17 is a chart illustrating changes in control conditions (flow rate and viscosity) according to the first embodiment of the present invention.

FIG. 18 is a chart illustrating changes in control conditions (flow rate and viscosity) according to a comparative example of the first embodiment of the present invention.

FIG. 19 is a chart illustrating changes in control conditions (flow rate and viscosity) according to a comparative example of the first embodiment of the present invention.

### DETAILED DESCRIPTION OF ILLUSTRATIVE EMBODIMENTS

### First Embodiment

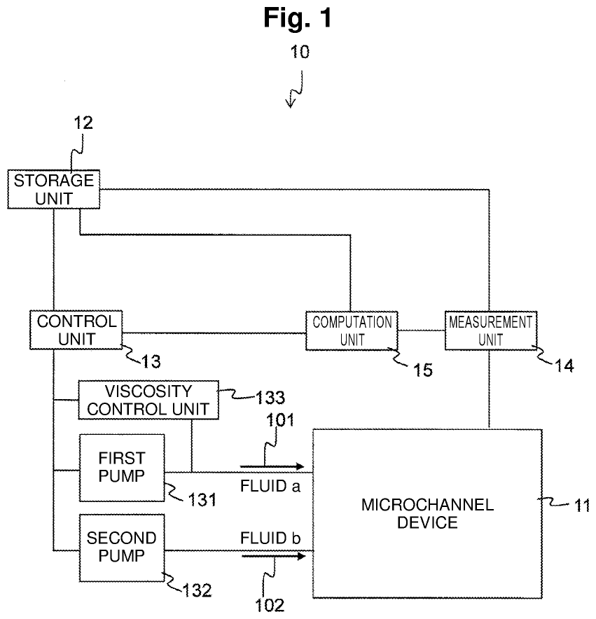

A particle sorting apparatus according to a first embodiment of the present invention will be described with reference to FIGS. 1 to 19.

<Configuration of Particle Sorting Apparatus>

FIG. 1 illustrates the basic configuration of a particle sorting apparatus 10 according to the present embodiment. The particle sorting apparatus 10 of the present embodiment includes a microchannel device 11, a storage unit 12, a control unit 13, a measurement unit 14, and a computation unit 15. Further, a first pump 131, a second pump 132, and a viscosity control unit 133 are connected to the control unit 13.

The microchannel device 11 receives a fluid containing particles (hereinafter referred to as a “fluid a”) 101 and a fluid not containing particles (hereinafter referred to as a “fluid b”) 102. The flow rate of the fluid a 101 when introduced into the microchannel device 11 is controlled by the first pump 131, and the flow rate of the fluid b 102 when introduced into the microchannel device 11 is controlled by the second pump 132.

The viscosity control unit 133 controls the viscosity of the fluid a 101 by mixing an anticoagulant into the fluid a 101 and increasing or decreasing the amount of the anticoagulant mixed. Herein, the anticoagulant may be stored in the viscosity control unit 133 or outside the microchannel device.

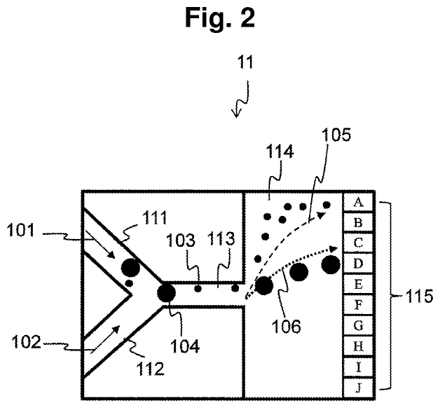

FIG. 2 illustrates a configuration example of the microchannel device 11 according to the present embodiment. In the configuration example herein, pinched flow fractionation (PFF) is used as a method for sorting particles (for example, Non-Patent Literature 1).

The microchannel device 11 includes a first inlet channel 11, a second inlet channel 112, a combined channel 113, a separation region 114, and a particle collection section 115.

The microchannel device 11 is produced with silicon through a common semiconductor device production process, such as exposure and patterning steps, for example.

The microchannel device 11 has a size of about 10 mm×20 mm. Each of the first inlet channel 11 and the second inlet channel 112 has a length of 4 mm and a width of 250 μm, and the combined channel 113 has a length of 100 μm and a width of 50 μm. In addition, each of the channels 111, 112, and 113, and the separation region 114 has a rectangular (including square) cross-section, and has a depth of 50 μm.

Although the angle made by the opposite side faces of the separation region 114 in the present embodiment is 180°, it may be 60° or any other angles.

The first inlet channel 111 receives the fluid a 101, and the second inlet channel 112 receives the fluid b 102. The fluid a 101 contains small particles 103 and large particles 104. The fluid a 101 and the fluid b 102 merge, and then flow through the combined channel 113 in a laminar flow state.

Herein, the flow rate and viscosity of each of the fluid a 101 and the fluid b 102 are controlled so that particles of each size flow through the combined channel 113 with a predetermined distance kept from one of the inner walls of the combined channel 113.

When the fluids flow into the separation region 114 from the combined channel 113, the distance of the particles of each size from the inner wall is increased so that the small particles 103 and the large particles 104 flow while being separated from each other. In FIG. 2, dashed line 105 indicates a flow of the small particles 103, and dotted line 106 indicates a flow of the large particles 104.

Consequently, the separated particles are collected into the particle collection section 115 that is divided into a plurality of collection zones. In the present embodiment, the particle collection section 115 is divided into 10 collection zones (A to J).

The control unit 13 controls each pump for introducing each fluid to control the flow rate of the fluid, and also controls the viscosity of the fluid.

The measurement unit 14 measures the number of particles collected into each of the collection zones (A to J) of the particle collection section 115 in the microchannel device 11. The number of particles may be measured with an optical method or through visual observation. Alternatively, it is also possible to capture a moving image for a certain period of time and confirm the number of particles while dividing the obtained moving image into still images. When the measurement is conducted through visual observation, the measured number of particles is input to the measurement unit 14.

The computation unit 15 calculates, in generating training data for machine learning, the separation rate of particles of each size separated into each collection zone (A to J) as separation result data, using the measured number of particles. Herein, the separation rate of particles of each size corresponds to (the measured number of particles in each collection zone)/(the total measured number of particles).

In addition, the computation unit 15 executes computation with a neural network when generating a trained model and performing inference in machine learning.

The storage unit 12 stores the separation result data (the separation rates) when generating training data. In addition, the storage unit 12 stores a trained model obtained with a neural network.

Although an example is illustrated herein in which the separation rates are used as the separation result data, it is also possible to use the number of particles measured in each of the collection zones (A to J) of the particle collection section 115 in the microchannel device 11. In addition, it is also possible to use an approximate curve, mean value, or standard deviation determined based on the measured number of particles, for example.

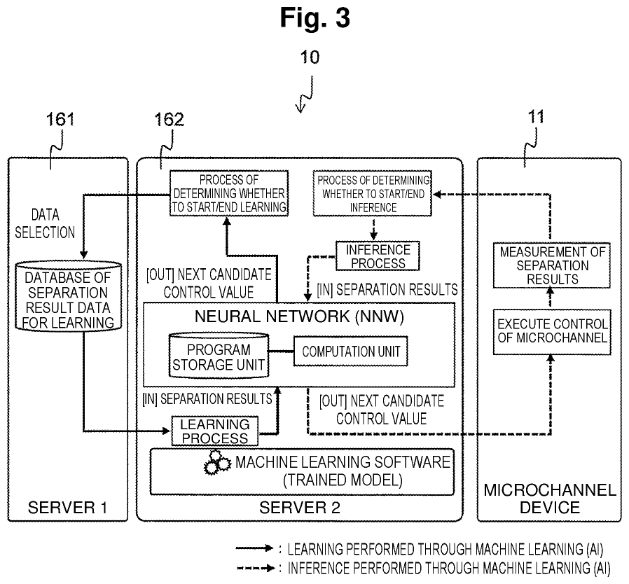

FIG. 3 illustrates a configuration example of the particle sorting apparatus 10 of the present embodiment. The particle sorting apparatus 10 includes the microchannel device 11, a first server 161, and a second server 162.

The first server 161 includes a database of the separation result data for learning. The separation result data for learning is generated based on data on the sorted (collected) particles obtained with the microchannel device 11.

The second server 162 includes a program storage unit and computation unit for executing a neural network.

When learning is performed through machine learning, separation result data read from the database of the separation result data for learning is input to a neural network, and calculation is performed with the computation unit, and then, candidate control conditions are output. It is determined if the output candidate control conditions satisfy a prescribed condition, and such determination is repeated until the prescribed condition is satisfied, so that a trained model (an inference model) is generated. The generated trained model (the inference model) is stored in the program storage unit.

When inference is performed through machine learning, the control conditions for the microchannel device 11 are computed based on separation result data obtained with the microchannel device 11, using the trained model (the inference model) read from the program storage unit, and then, the microchannel device 11 is controlled based on the output conditions. Such computation is repeated until the resulting separation result data satisfies a prescribed condition so that the control conditions are optimized.

In the configuration example herein, the storage unit 12 illustrated in FIG. 1 includes the database of the separation result data for learning and the storage unit of the neural network, and the computation unit 15 illustrated in FIG. 1 includes the computation unit of the neural network. The control unit 13 illustrated in FIG. 1 may be arranged either in the microchannel device 11 or in the server 161 or 162.

Although two servers are used in the configuration example herein, a single server may include the database of the separation result data for learning as well as the program storage unit and the computation unit of the neural network.

<Method for Generating Training Data>

Training data is generated using the microchannel device 11 of the present embodiment. For generating training data, microbeads are used as particles, and separation result data obtained with the microchannel device 11 based on the size of the particles is acquired.

The fluid (a suspension or the fluid a) 101 containing particles of two sizes is introduced through the first inlet channel 111 of the microchannel device 11. The particles of two sizes include those with a particle diameter of 2 to 3 μm and those with a particle diameter of 50 m.

The fluid a 101 is viscous, and the viscosity is changed in the range of 0.1 to 10 mPa·s by changing the content of an anticoagulant in the fluid a 101. In addition, the flow rate of the fluid a 101 is changed in the range of 1 to 100 μL/min by controlling the first pump 131.

The fluid (the fluid b) 102 not containing particles is introduced through the second inlet channel 112 of the microchannel device 11. In the present embodiment, pure water is used as the fluid b 102, and the flow rate of the fluid b 102 is changed in the range of 1 to 100 μL/min by controlling the second pump 132.

The particles contained in the fluid a 101 introduced through the first inlet channel 11 are, after having passed through a single channel, separated in the separation region 114 according to particle size, and are then collected into the collection zones A to J.

In such a microchannel device 11, the flow rate of each of the fluid a 101 and the fluid b 102 and the viscosity of the fluid a 101 are changed, and the number of particles collected into each of the collection zones A to J is measured for each particle size, and then, the separation rate of the particles of each size is calculated.

Consequently, the separation rate of the particles of each size separated into each of the collection zones A to J is obtained corresponding to the control conditions (the flow rate of each of the fluid a 101 and the fluid b 102 and the viscosity of the fluid a 1i) for the microchannel device 11.

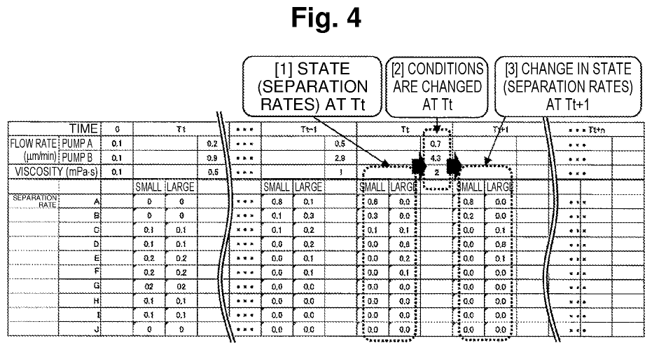

As an example, FIG. 4 illustrates changes in the separation results (the separation rates) when the control conditions for the microchannel device 11 are changed. FIG. 4 illustrates, with respect to the separation results at a time Tt (indicated by [1] in FIG. 4), separation results at a time Tt+1 (indicated by [3] in FIG. 4) after arbitrary control has been randomly executed (the control conditions have been changed; indicated by [2] in FIG. 4).

Changing the control conditions for the microchannel device 11 allows for excellent separation of the particles into small particles and large particles in the particle collection section 115 at Tt+1 such that the separation rate of small particles separated into the collection zone A is 0.8 and the separation rate of large particles separated into the collection zone D is 0.8.

Further, reward values are set for the data. The reward values are set by focusing on the position that can be easily reached by particles of each size based on the shape of the channel.

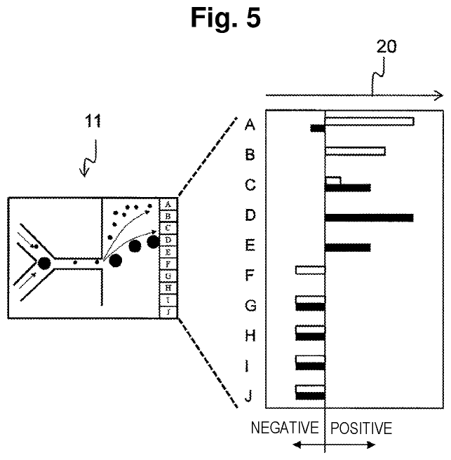

FIG. 5 schematically illustrates the setting of reward values 20 in the present embodiment. In the present embodiment, not a single reward value 20 is set for a single collection zone, but different reward values 20 are set for a plurality of collection zones. Consequently, the reward values 20 are distributed across a plurality of collection zones among the collection zones A to J. Further, not only positive values but also negative values are used as the reward values 20.

Herein, the reward values 20 are set by focusing on the collection zone that can be easily reached by particles of each size (hereinafter referred to as a “target collection zone”) based on the shape of the channel such that the reward value 20 for small particles collected into the target collection zone A is the maximum and the reward value 20 for large particles collected into the target collection zone D is the maximum.

More specifically, the reward values 20 for small particles are set as positive values such that the value for the target collection zone A is the highest, the value for the collection zone B is the second highest, and the value for the collection zone C is the lowest. Meanwhile, the reward values 20 for large particles are set as positive values such that the value for the target collection zone D is the maximum, and the value decreases from the collection zone D to the collection zone C and also from the collection zone D to the collection zones E and F.

Meanwhile, negative reward values are set for positions that are unlikely to be reached by particles. Specifically, for small particles, negative reward values 20 are set for the collection zones F to J. Meanwhile, for large particles, negative reward values 20 are set for the collection zones G to J.

In this manner, the reward values 20 are set such that the reward value 20 is maximum for the target collection zone determined for each size of the particles, and the reward value 20 decreases in a direction away from the target collection zone, and further, the maximum reward value is a positive value and the minimum reward value is a negative value.

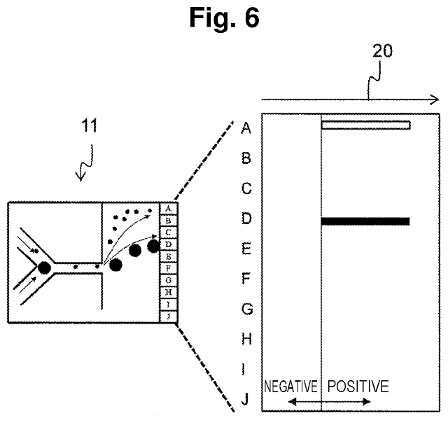

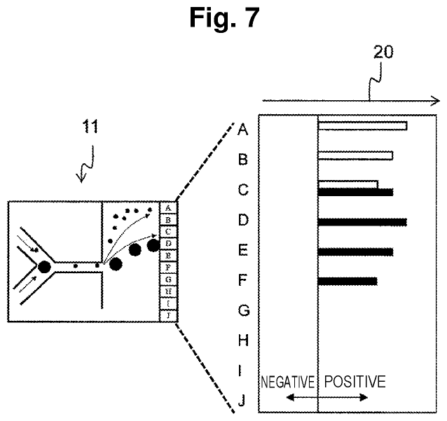

For comparison purposes, Comparative Example 1 and Comparative Example 2 are also prepared in which the reward values 20 are set with a distribution different from that of the present embodiment. FIGS. 6 and 7 schematically illustrate the setting of the reward values 20 according to Comparative Examples 1 and 2, respectively.

In Comparative Example 1, the reward value 20 for small particles is set only for those collected into the collection zone A, and the reward value 20 for large particles is set only for those collected into the collection zone D.

In Comparative Example 2, not a single reward value 20 is set for a single collection zone, but different reward values 20 are set for a plurality of collection zones. Consequently, the reward values 20 are distributed across a plurality of collection zones among the collection zones A to J.

Herein, the reward values 20 are set by focusing on the position that can be easily reached by particles of each size based on the shape of the channel such that the reward value 20 for small particles collected into the collection zone A is the maximum and the reward value 20 for large particles collected into the collection zone D is the maximum.

More specifically, the reward values 20 for small particles are set such that the value for the collection zone A is the highest, the value for the collection zone B is the second highest, and the value for the collection zone C is the lowest. Meanwhile, the reward values 20 for large particles are set such that the value for the collection zone D is the maximum, and the value decreases from the collection zone D to the collection zone C and also from the collection zone D to the collection zones E and F. Herein, the reward values are set greater than or equal to zero.

Finally, each reward value set herein is multiplied by the separation rate for each collection zone for each control condition, that is, at a time Tt+1 so that the summation is calculated.

$$\begin{matrix}Equation 1 & \\ S ( Tt ) = {\sum }_{area = A}^{J} ( R ( {T}_{t + 1} ) \times r ) & ( 1 )\end{matrix}$$

Herein, provided that S(Tt) is a score of the control conditions at a time Tt, R(Tt+1) is the separation result (the separation rate) at a time Tt+1, and r is the reward value, the summation of R(Tt+1) multiplied by r over the collection zones (area) A to J is calculated.

The summation calculated from Expression (1) is a score indicating the validity of the control conditions. Therefore, it is possible to determine from the score which type of control should be performed in response to given separation results to obtain an optimum result. Herein, performing determination based on the score obtained by multiplying each separation rate by each reward value will clarify the difference between the conditions to be not optimized and the conditions to be optimized, and thus allow for easy determination of the conditions to be optimized.

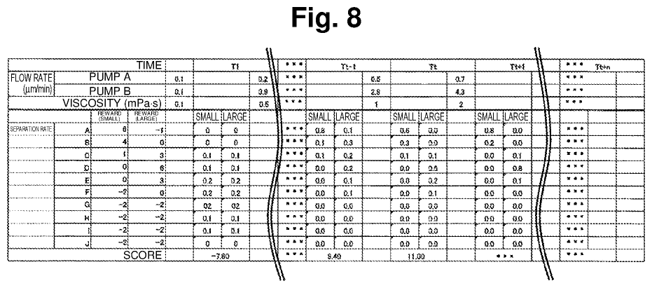

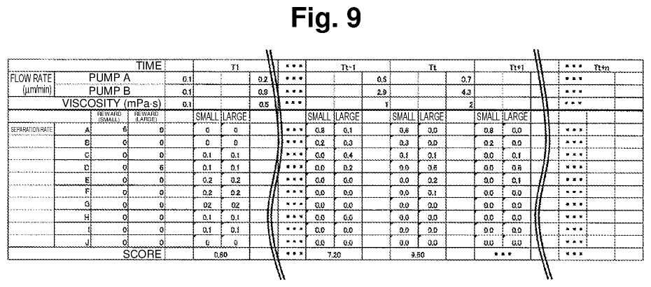

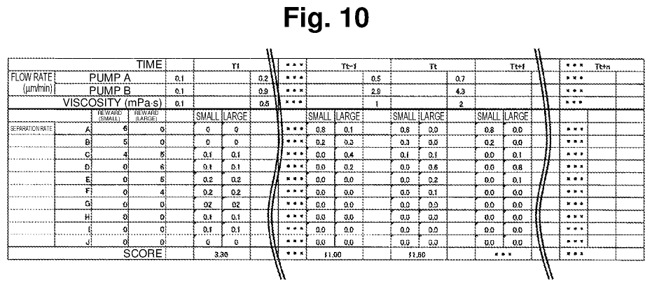

FIG. 8 illustrates an example of training data according to the present embodiment. FIGS. 9 and 10 respectively illustrate examples of training data according to Comparative Example 1 and Comparative Example 2.

The training data includes data on the aforementioned control conditions, data on the separation results (the separation rates) obtained through measurement, and a score calculated with the reward values. When both large particles and small particles were separated into the collection zones A to J at a time Tt, the control conditions are set (changed from the conditions at the time Tt) and the apparatus is operated. Then, a score calculated from the separation rates obtained at a time Tt+1 is used as a score for the time Tt.

In Comparative Example 1, the scores indicate values of 0.6 to 9.6, and in Comparative Example 2, the scores indicate values of 3.3 to 11.6. Meanwhile, in the present embodiment, the scores indicate values of −7.6 to 11.0.

As described above, the scores of the present embodiment have a distribution including both negative values and positive values, and there is a great difference between the maximum value and the minimum value. This clarifies the difference between acceptable separation results and unacceptable separation results, and thus indicates that it is possible to easily perform determination in generating a trained model (an inference model) and performing inference and thus increase the processing speed.

In the present embodiment, the training data includes a value obtained by multiplying each piece of the separation result data by each reward value, but the training data may include only the separation result data, and in such a case, the separation result data may be multiplied by the reward value when a trained model described below is generated.

<Method for Generating Trained Model>

A method for generating a trained model (an inference model) through machine learning using the aforementioned training data will be described. In the present embodiment, a neural network is used for machine learning.

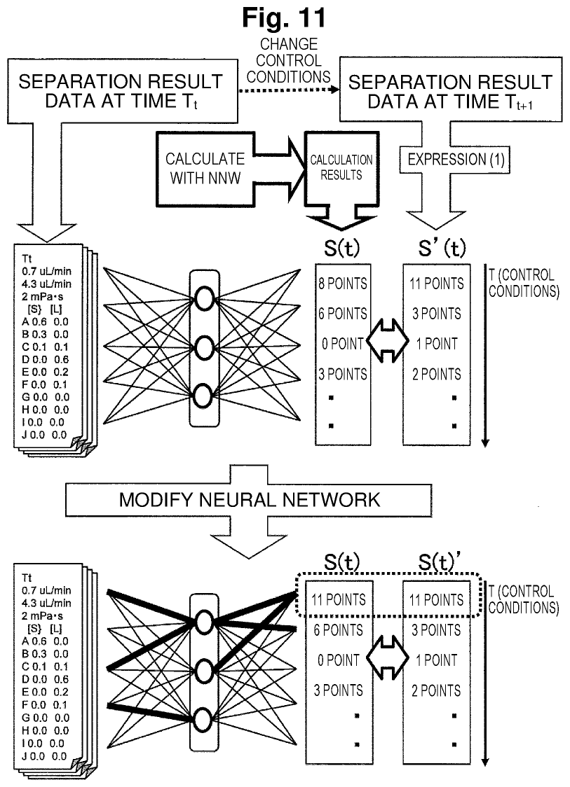

FIG. 11 schematically illustrates a method for generating a trained model (an inference model) through machine learning.

Data on the separation results (the separation rates) at a time Tt is input to a neural network so that a score is calculated. Specifically, the control conditions are set (changed) for the separation rates for the collection zones A to J at the time Tt, and then, separation rates at a time Tt+1 are obtained. The obtained separation rates are multiplied by the reward values so that a score is calculated.

Therefore, scores of different control conditions are obtained at different times Tt. Thus, randomly selecting times Tt and performing calculation with the neural network can obtain a set of scores S(t) including a plurality of scores.

Meanwhile, data on the separation results (the separation rates) at the time Tt+1 corresponding to the time Tt in the training data is obtained from the storage unit 12. Obtaining the separation result data at times Tt+1 corresponding to the aforementioned randomly selected times Tt and performing calculation with Expression (1) can obtain a set of scores S′(t) including a plurality of scores as teaching data.

Herein, when the training data includes a score obtained by multiplying each piece of the separation result data by each reward value, the set of scores S′(t) may be obtained based on the value of such score.

An error (hereinafter referred to as “loss”) between the sets of scores S(t) and S′(t) is calculated with the least-squares method.

The neural network is repeatedly modified to allow the loss to be within a convergence condition so that a trained model (an inference model) is generated.

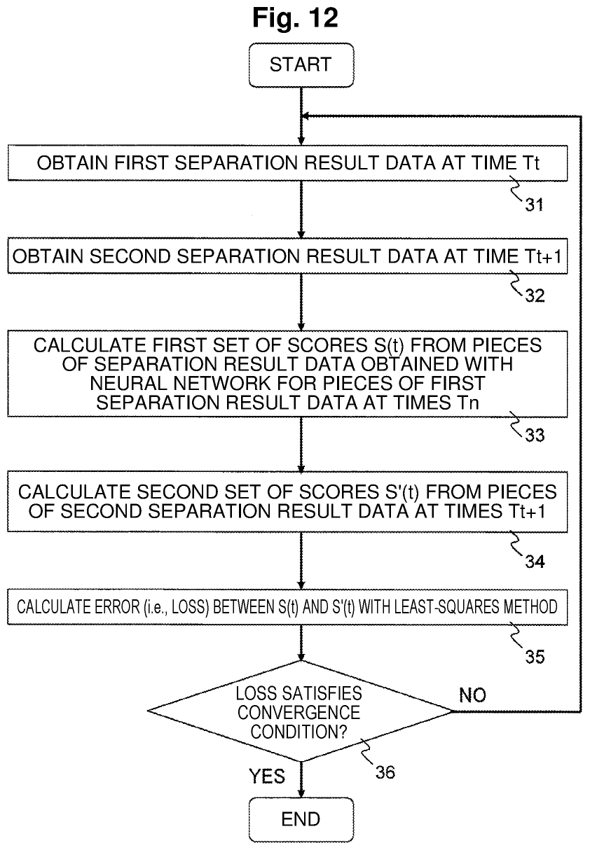

FIG. 12 is a flowchart for generating a trained model (an inference model) through machine learning.

First, data on the separation results (the separation rates) at a time Tt (a first time point) (hereinafter referred to as “first separation result data”) is randomly obtained from the storage unit 12 (step 31).

In addition, data on the separation results at a time Tt+1 (a second time point) corresponding to the time Tt (hereinafter referred to as “second separation result data”) is obtained from the storage unit 12 (step 32).

Next, the first separation result data at the time Tt is input to a neural network. Then, the control conditions are set (changed) for the first separation result data at the time Tt, and separation result data at the time Tt+1 is output.

Next, a score (hereinafter referred to as a “first score”) is calculated from Expression (1) using the output separation result data.

Pieces of separation result data at a plurality of arbitrary times Tt are selected as the first separation result data, and calculation is similarly performed on pieces of separation result data at times Tt+1 obtained with the neural network so that a set of scores (hereinafter referred to as a “first set of scores”) S(t) including a plurality of scores (first scores) is obtained (step 33).

Next, a score (hereinafter referred to as a “second score”) is calculated from Expression (1) using the second separation result data at the time Tt+1.

Pieces of separation result data at a plurality of times Tt+1, which correspond to the times Tt of the aforementioned plurality of selected pieces of first separation result data, are selected as the second separation result data so that a set of scores (hereinafter referred to as a “second set of scores”) S′(t) including a plurality of scores (second scores) obtained from Expression (1) is acquired in a similar manner (step 34).

Next, an error (loss) between the first set of scores S(t) and the second set of scores S′(t) is calculated with the least-squares method. In this manner, the first set of scores S(t) and the second set of scores S′(t) are compared (step 35).

Although the present embodiment has illustrated an example in which data at the time Tt and data at the time Tt+1 are obtained one by one, the present invention is not limited thereto. It is also possible to collectively obtain data at the time Tt and data at the time Tt+1. For example, it is possible to collectively obtain sets of data at T3, T4, T10, and T11 . . . and calculate an error between scores, such as a score calculated from T3 and a score of T4 (teaching data), or a score calculated from Ti and a score of Ti (teaching data).

In addition, it is possible to obtain not only two adjacent pieces of data, such as data at the time Tt and data at the time Tt+1, but also data at a time Tt+n corresponding to the time Tt, and weight the neural network by reflecting the results at the time Tt+n in the data at the time Tt.

Next, it is determined if the loss satisfies a convergence condition (step 36). If the loss does not satisfy the convergence condition, the neural network is modified using the error backpropagation method so that learning is started again.

Meanwhile, if the loss satisfies the convergence condition, the machine learning ends. In the present embodiment, the convergence condition is assumed that the loss is stabilized less than or equal to 0.4.

The convergence condition is not limited to that of the present embodiment, and may be any other values or a reference value at a predetermined time. Alternatively, the convergence condition may be a mean value for a predetermined time period.

Accordingly, when the machine learning ends, a trained model (hereinafter referred to as an “inference model”) is generated. As described above, the trained model (the inference model) includes data on the control conditions and data on the separation results. Further, the trained model (the inference model) also includes reward values and scores.

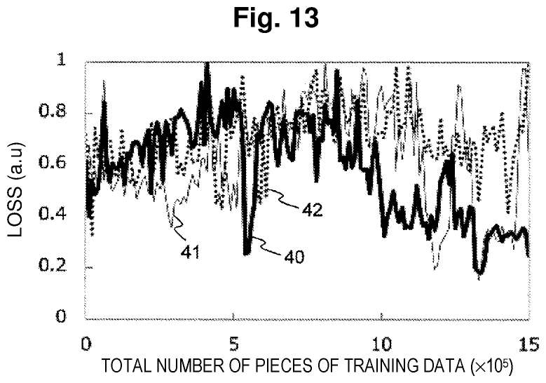

FIG. 13 illustrates changes in loss during a process of generating a trained model (an inference model). Changes in loss of the present embodiment are indicated by thick line 40. Changes in loss of Comparative Example 1 and Comparative Example 2 are respectively indicated by thin line 41 and dotted line 42.

In Comparative Example 1 and Comparative Example 2, with a total of 15×10⁵ pieces of training data, loss is not stabilized (does not converge) less than or equal to the reference value (0.4). Meanwhile, in the present embodiment, with a total of 15×10⁵ pieces of training data, loss is stabilized (converges) less than or equal to the reference value (0.4).

In this manner, in Comparative Example 1 and Comparative Example 2, more than 15×10⁵ pieces of training data are required for generating a trained model (an inference model), while in the present embodiment, about 15×10⁵ pieces of training data are required for generating a trained model (an inference model).

As described above, according to the present embodiment, reward values are set with a distribution including both negative values and positive values. This can increase the processing speed of the generation of a trained model (an inference model).

The inference model generated in the aforementioned manner is stored in the storage unit 12 of the particle sorting apparatus 10, and is used for the inference for optimizing the control conditions for the particle sorting apparatus 10.

<Inference Performed with Particle Sorting Apparatus>

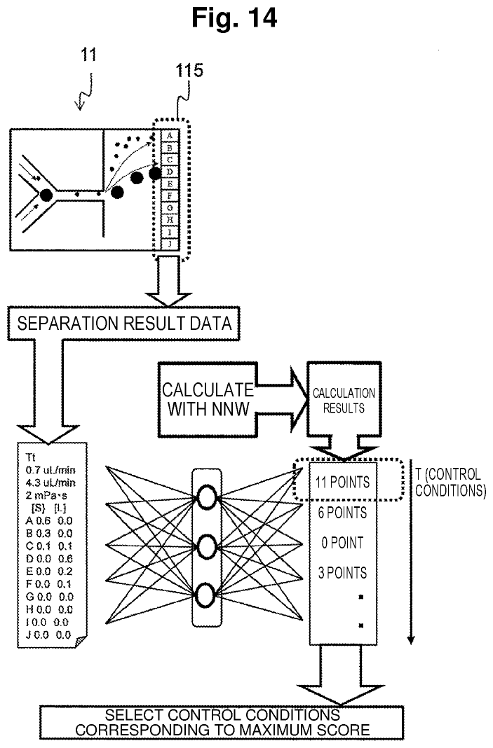

Hereinafter, inference performed with the particle sorting apparatus 10 will be described. FIG. 14 schematically illustrates inference performed with the particle sorting apparatus 10.

Separation result data obtained with the microchannel of the particle sorting apparatus 10 is input to a neural network. In the neural network, a plurality of pieces of data (separation result data at Tt) similar to the input separation result data are selected from among the pieces of stored data. Then, separation result data at Tt+1 corresponding to each piece of the data is extracted, and a score is calculated with each piece of the extracted data.

Control condition data, which corresponds to the maximum score of the calculated scores, is selected, and the particle sorting apparatus 10 is operated under the selected control conditions. Such a process is repeated until a score calculated with separation result data obtained as a result of the operation has reached a prescribed value.

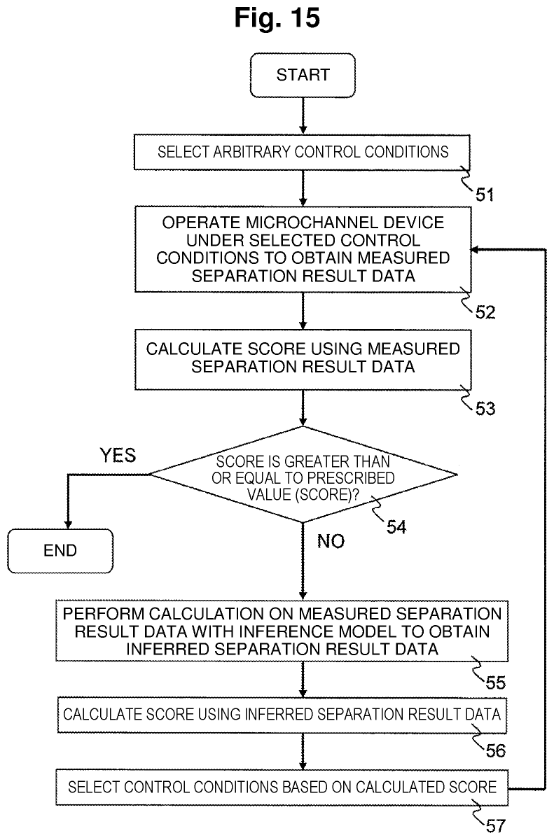

FIG. 15 illustrates a flowchart for generating a trained model (an inference model) through machine learning.

First, arbitrary conditions for controlling the particle sorting apparatus 10 are selected (step 51).

Next, the particle sorting apparatus 10 is operated under the selected conditions, and the number of separated particles is measured so that separation result data (hereinafter referred to as “measured separation result data”) is obtained (step 52).

Next, a score is calculated from Expression (1) using the measured separation result data (step 53).

Next, determination is performed by comparing the calculated score with a prescribed value (step 54). If the score is greater than or equal to the prescribed value, the inference ends. Herein, a predetermined value, such as 10, may be set as a score of the prescribed value, for example, but the present invention is not limited thereto. For example, it is possible to use a mean value of the top scores obtained through execution of inference a predetermined number of times.

Meanwhile, if the score is less than the prescribed value, the following inference is executed.

Next, calculation is performed on the measured separation result data with an inference model (a neural network) so that separation result data (hereinafter referred to as “inferred separation result data”) is obtained (step 55). Herein, in the inference model, a plurality of pieces of separation result data similar to the measured separation result data are selected from among the pieces of separation result data at Tt stored in the storage unit 12, and separation result data at Tt+1 corresponding to each piece of the separation result data at Tt is output as the inferred separation result data.

Herein, as the separation result data similar to the measured separation result data, data is selected that has the same order of collection zones, from a collection zone with a high separation rate to a collection zone with a low separation rate, as that of the measured separation result data.

Alternatively, as the separation result data similar to the measured separation result data, it is also possible to select data within a predetermined error range (for example, 10%) from the measured separation result data in terms of an approximate curve of a distribution of the separation rates for the collection zones. Alternatively, it is also possible to select data with a difference between a mean value for regions with a high separation rate and a mean value for regions with a low separation rate being within a predetermined range (for example, 10%).

Next, a score is calculated from Expression (1) using the inferred separation result data (step 56).

Next, control conditions, which correspond to the inferred separation result data indicating the maximum score among the scores calculated from the pieces of inferred separation result data, are selected (step 57).

Next, the particle sorting apparatus 10 is operated under the selected control conditions so that measured separation result data is obtained (step 52). After step 52, inference is executed in a manner similar to that described above.

As described above, the control conditions when the inference has ended through the determination in step 54 is the optimum control conditions. Controlling the particle sorting apparatus 10 under such conditions can excellently sort particles according to particle size at the time point when the control is performed.

As described above, the conditions for controlling the microchannel device 11 are determined using the trained model obtained through machine learning of the aforementioned control condition data and separation result data.

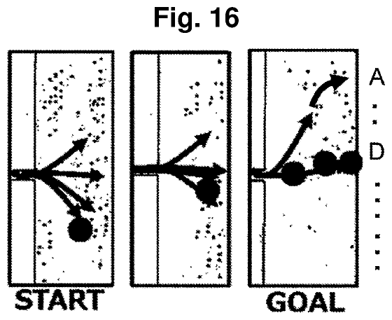

FIG. 16 illustrates an aspect in which particles are sorted during the process of inference. At the beginning of the inference, the control conditions are not optimized, and particles diffuse in many directions and thus are not sorted excellently. However, at the end of the inference, the control conditions are optimized and particles are sorted excellently such that small particles are collected into the collection zone A and large particles are collected into the collection zone D.

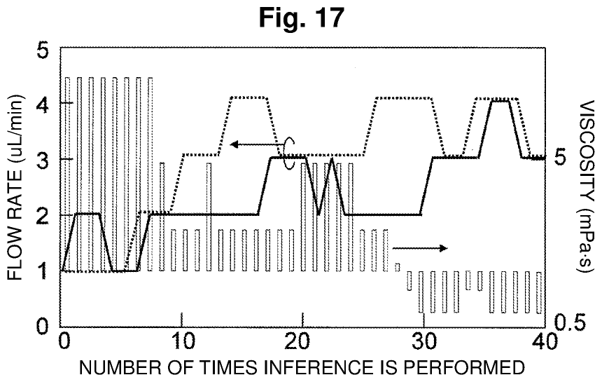

FIG. 17 illustrates changes in the control conditions (flow rate and viscosity) according to the present embodiment. Hereinafter, in the chart, a line graph (of a dotted line) indicates the flow rate of the fluid a, a line graph (of a solid line) indicates the flow rate of the fluid b, and a bar graph indicates the viscosity of the fluid a. When inference has been performed 40 times, each of the flow rate and viscosity converges to a constant value so that the sorting of particles is complete.

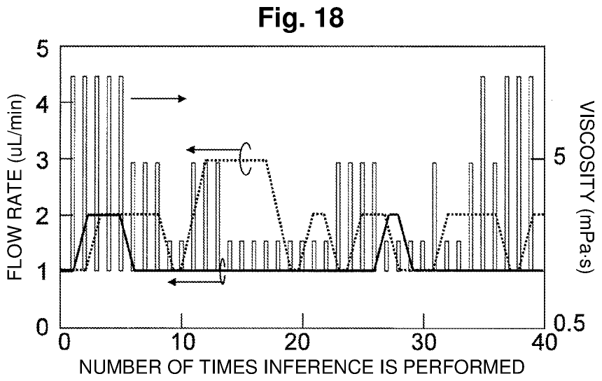

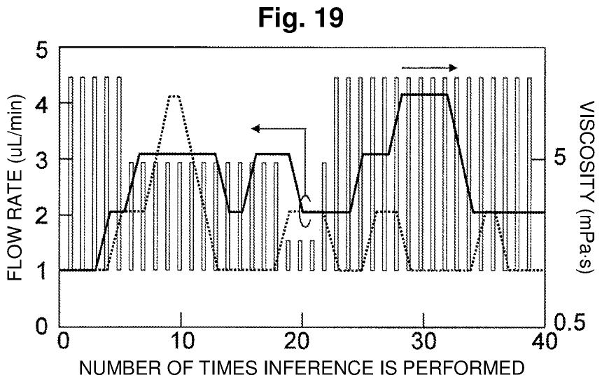

FIGS. 18 and 19 respectively illustrate changes in the control conditions (flow rate and viscosity) in the process of inference according to Comparative Example 1 and Comparative Example 2. In each of Comparative Example 1 and Comparative Example 2, when inference has been performed 40 times, neither the flow rate nor the viscosity converges to a constant value, and thus, the sorting of particles is not complete.

As described above, in each of Comparative Example 1 and Comparative Example 2, it is necessary to perform inference more than 40 times to optimize the control conditions, while in the present embodiment, it is possible to optimize the control conditions and complete the sorting of particles by performing inference about 40 times.

According to the present embodiment, it is possible to optimize the control conditions (flow rate and viscosity) and sort particles through a smaller number of inferences performed in comparison with Comparative Example 1 and Comparative Example 2. That is, the processing speed of the inference can be increased.

As described above, according to the present embodiment, reward values are set with a distribution including both positive values and negative values across the collection zones. This can increase the difference among the scores used for the determination of whether the control conditions are acceptable or not. Thus, it is possible to clearly determine whether the control conditions are acceptable or not. Consequently, it is possible to complete the generation of a trained model (an inference model) and the optimization of the control conditions through a small number of processes, and thus increase the processing speed.

As described above, for the particle sorting apparatus according to the embodiment of the present invention, the data structure of the particle sorting data includes control condition data for the microchannel device and the separation result data paired with the control condition data and is used for a process of the computation unit to determine the condition for controlling the microchannel device using the trained model obtained through machine learning of the control condition data and the separation result data obtained from the storage unit.

The particle sorting apparatus according to the embodiment of the present invention can be implemented by a computer including a CPU (Central Processing Unit), a storage device (a storage unit), and an interface; and a program that controls such hardware resources.

For the particle sorting apparatus according to the embodiment of the present invention, the computer may be provided in the apparatus, or at least some of the functions of the computer may be implemented using an external computer. In addition, for the storage unit also, a storage medium outside of the apparatus may be used, and in such a case, a particle sorting program stored in the storage medium may be read and executed. Examples of the storage medium include a variety of magnetic recording media, magnetooptical recording media, CD-ROM, CD-R, and a variety of memories. In addition, the particle sorting program may be supplied to the computer via a communication line, such as the Internet.

Although a microchannel device including two inlet channels has been exemplarily described as the microchannel device of the embodiment of the present invention, the present invention is not limited thereto. It is acceptable as long as the microchannel device includes a plurality of inlet channels. It is acceptable as long as at least one of the plurality of inlet channels receives a fluid not containing particles, and the other inlet channels receive a fluid containing particles, and also, a viscosity control unit, which is controlled by a control unit, is connected to at least one of the other inlet channels. Further, the collection zones of the particle collection section are not limited to the 10 collection zones A to J, and it is acceptable as long as a plurality of collection zones are provided.

Although pinched flow fractionation (PFF) is used as a method for sorting particles with the microchannel device of the embodiment of the present invention, the present invention is not limited thereto. It is also possible to use other methods, such as field flow fractionation, and it is acceptable as long as a method is used in which a flow of a fluid containing particles is controlled based on the flow rate, viscosity, and the like, and the particles are separated according to particle size.

Although an example in which particles are sorted into two sizes (small particles and large particles) has been described for the particle sorting apparatus according to the embodiment of the present invention, the present invention is not limited thereto, and particles may be sorted into a plurality of sizes. In such a case, a plurality of target collection zones may be set in conformity with the size of the plurality of particles.

Although the embodiments of the present invention have illustrated examples of the structure, dimensions, and material of each component regarding the configuration of the particle sorting apparatus, the production method, and the like, the present invention is not limited thereto. It is acceptable as long as the functions and effects of the particle sorting apparatus are achieved.

### INDUSTRIAL APPLICABILITY

Embodiments of the present invention are applicable in the industrial field, pharmaceutical field, medicinal chemistry field, and the like as an apparatus or technique for sorting particles, such as resin beads, metal beads, cells, pharmaceuticals, emulsions, or gels.

### REFERENCE SIGNS LIST

10 Particle sorting apparatus
11 Microchannel device
12 Storage unit
13 Control unit
14 Measurement unit
15 Computation unit.

1.-8. (canceled)

9. A particle sorting apparatus for separating particles according to sizes of the particles, the particle sorting apparatus comprising:
a microchannel device;
a computation circuit configured to determine a condition for controlling the microchannel device using a trained model obtained through machine learning of control condition data and separation result data that have been obtained by separating particles while controlling the microchannel device; and
a controller configured to control the microchannel device based on the condition.

10. The particle sorting apparatus according to claim 9, wherein the computation circuit determines the condition based on a score obtained by multiplying the separation result data by a reward value determined for each of a plurality of collection zones in the microchannel device.

11. The particle sorting apparatus according to claim 10, wherein the reward value is maximum for a target collection zone determined for each size of the particles, wherein the reward value decreases in a direction away from the target collection zone, wherein a maximum reward value is a positive value, and wherein a minimum reward value is a negative value.

12. The particle sorting apparatus according to claim 9, wherein the microchannel device includes:
a plurality of inlet channels that are respectively configured to receive a plurality of fluids with flow rates controlled by the controller;
a combined channel connected to the plurality of inlet channels, the combined channel being configured to combine the plurality of fluids;
a separation region connected to the combined channel, the separation region being configured to pass particles contained in the combined fluids while separating the particles according to particle size; and
a particle collection section including a plurality of collection zones configured to collect separated ones of the particles for each particle size.

13. The particle sorting apparatus according to claim 12, wherein at least one of the plurality of inlet channels receives a fluid not containing particles, and other inlet channels of the plurality of inlet channels receive a fluid containing particles.

14. The particle sorting apparatus according to claim 13, wherein a viscosity controller controlled by the controller is connected to at least one of the other inlet channels.

15. A particle sorting method for separating particles according to sizes of the particles using a microchannel device, the method comprising:
a step of determining a condition for controlling the microchannel device using a trained model obtained through machine learning of control condition data and separation result data that have been obtained by separating particles while controlling the microchannel device; and
a step of controlling the microchannel device based on the condition.

16. The method according to claim 15 further comprising generating the trained model, wherein generating the trained model comprises:
a step of obtaining, from training data including the control condition data and separation result data that have been obtained by separating particles while controlling a microchannel device at a first time point, first separation result data at the first time point;
a step of obtaining, from training data including control condition data and separation result data that have been obtained by separating particles while controlling the microchannel device at a second time point, second separation result data at the second time point;
a step of calculating a first score by multiplying separation result data obtained through machine learning of the first separation result data by a reward value;
a step of calculating a second score by multiplying the second separation result data by the reward value; and
a step of comparing the first score with the second score.

17. A non-transitory computer-readable media storing computer instructions for separating particles according to sides of the particles using a microchannel device, that when executed by one or more processors, cause the one or more processors to perform the steps of:
a step of determining a condition for controlling the microchannel device using a trained model obtained through machine learning of control condition data and separation result data that have been obtained by separating particles while controlling the microchannel device; and
a step of controlling the microchannel device based on the condition.

18. The non-transitory computer-readable media storing the computer instructions for separating the particles according to claim 17, the instructions comprising further instructions for generating the trained model, wherein the instructions for generating the trained model comprises:
a step of obtaining, from training data including the control condition data and separation result data that have been obtained by separating particles while controlling a microchannel device at a first time point, first separation result data at the first time point;
a step of obtaining, from training data including control condition data and separation result data that have been obtained by separating particles while controlling the microchannel device at a second time point, second separation result data at the second time point;
a step of calculating a first score by multiplying separation result data obtained through machine learning of the first separation result data by a reward value;
a step of calculating a second score by multiplying the second separation result data by the reward value; and
a step of comparing the first score with the second score.
